(19) United States
(12) Patent Application Publication
(10) Pub. No.: US 2011/0056352 A1
(43) Pub. Date: Mar. 10, 2011

(54) Device for the Automated Cutting of Bread into Slices

(76) Inventor: Baudouin Van Cauwenberghe, Alsemberg (BE)

(21) Appl. No.: 10/574,105

(22) PCT Filed: Oct. 4, 2004
(86) PCT No.: PCT/BE04/00139

§ 371 Date: Apr. 20, 2007

(30) Foreign Application Priority Data
Oct. 2, 2003 (EP) 03447243.1

(51) Int. Cl. B26D 5/00

(52) U.S. Cl. 83/74

(57) ABSTRACT

A device 1 for the automated cutting of bread 4 into slices comprising an element 7 driving the bread 4 and a set of blades 8 for slicing the bread 4, the drive element 7 being arranged so as to be moved in a translation movement transversely to the set of blades 8 by a movement means 10 coupled to said drive element 7, between a first retracted position in which the bread 4 to be sliced can be loaded into the device 1 and a second advanced position in which the element 7 driving the bread 4 is adjacent to the set of blades 8 and the sliced bread can be removed from the device 1, the latter also comprising a regulation means 14 arranged to automatically regulate the power supplied by the movement means 10 according to the speed and/or acceleration of the translation movement of the element 7 driving the bread 4 during the operation of slicing it. Said regulation means 14 is arranged to compare the speed of movement of the drive element 7 with a predetermined speed and to respectively increase or reduce the power of the means 10 of moving said drive element 7 when said speed of movement is respectively less than or greater than the predetermined speed.

The present invention concerns a device for the automated cutting of bread into slices.

Devices for the automated cutting of bread into slices are well known. They are encountered in the majority of traditional bakeries and also in supermarkets. These devices, or automatic bread slicers, function according to the following principle: the user of the device introduces therein the bread that he wishes to cut into slices, placing it in a compartment disposed between an element for driving the bread and a set of parallel blades intended to slice said bread. The user then starts up the device by triggering the switch provided for this purpose, which causes the reciprocating movement of the blades and the translation movement, transversely to the direction of the blades, of the element driving the bread. The bread is consequently moved by this drive element in the direction of the blades and slicing commences when it comes into contact with the latter. The user recovers his bread, cut into slices, in a compartment disposed on the side of the blades opposite to that where the bread loading compartment is disposed in the device. All that the user then has to do is to wrap the sliced bread.

In the traditional automatic bread slicing devices, the power of the motor driving the element driving the bread is constant and consequently cannot be adapted to the type of bread whose slicing is required, according to the speed of movement of the element driving the bread during the slicing operation. This poses a problem with regards to the quality of the bread slicing. This is because, in the case of a bread with a flexible crust and soft inside, an excessively high power supplied by the motor and therefore an excessively great speed of the bread driving element will cause an excessively great pressure on the bread at the start of cutting and consequently a crushing of the latter on the blades and a tearing of the inside during slicing. The quality of the slicing of the bread consequently will be poor since the slices will have a squashed appearance on the side of the edge thereof attacked by the blades and tearing of the inside. The same applies with a bread having a hard crust and a soft inside since in this case an excessively high power of the motor and therefore an excessively great speed of the bread driving element when the cutting starts will also give rise to an excess pressure on the crust when it is attacked by the blades and consequently a breaking of the crust against the blade and a consequent crumbling of it, following by a tearing of the inside as disclosed above during slicing. On the other hand, in the case of a bread with firm crust and inside an excessively low power of the motor and therefore an excessively slow speed of the bread pushing device may have the consequence of a lack of pressure on the bread during the cutting and consequently an excessively prolonged rubbing of the blades of the machine on the inside of the bread, which will cause crumbling and pilling of the latter by the blades. This will also be the case when a bread with a hard crust and firm inside is sliced since the slicing of the crust at the start of slicing will for its part be correct but that of the inside subsequently will also be too slow and may therefore give rise to the appearance of the above-mentioned crumbling and pilling.

It has been attempted to resolve this problem of inadaptation of the power of the motor driving the element driving the bread to the nature of the latter by providing the drive element with a system controlling the power of its motor and therefore the speed of the element driving the bread and consecutively the pressure it exerts on the bread during slicing. Such a system can consist of a lever enabling the user of the device to manually control the element driving the bread in the machine or an electrical control for increasing or reducing the power of the motor driving the drive element during the slicing of said bread.

Nevertheless, these systems pose another problem since they always require an intervention by the user to control them and consequently on the one hand a certain experience on the part of the latter with regard to types of bread and optimum slicing conditions associated with each of these types and on the other hand a mobilization of the user throughout the bread slicing time in order to control the system controlling the element driving this bread in the device.

It has also been attempted to resolve this problem by proposing, according to the teachings of the patent U.S. Pat. No. 3,875,840, a system controlling the power of a first motor actuating the bread driving element, comprising a second motor comprising at least one spring or a counterweight able to slide on an inclinable guide, so as to oppose the action of the first according to the force exerted by the element driving the bread on the blades slicing the latter and therefore the speed and/or acceleration of said drive element. Such a system is however mechanically complex in its design and not very reliable and precise in its functioning.

The present invention resolves the above-mentioned problems and mitigates the drawbacks associated therewith by proposing a device for the automated cutting of bread into slices in which the speed of the bread driving element is automatically adapted to the type of bread to be sliced and in particular to the hardness of its crust and to the firmness of its inside, and this throughout the slicing operation.

Consequently the invention consists of a device for the automated cutting of bread into slices comprising an element driving the bread arranged so as to be moved by means of a movement means coupled to said element between a first retracted position in which the bread to be sliced can be loaded in the device and a second advanced position in which the sliced bread can be removed from the device, the latter also comprising a set of bread slicing blades disposed substantially parallel to one another and arranged so as to be driven in an alternating reciprocating movement, the bread driving element being arranged so as, when the device is in operation, to drive the bread in a translation movement towards and through the set of blades between the first and second position of said element, the device also comprising a regulation means arranged to automatically regulate the power supplied by the movement means according to the speed and/or acceleration of the translation movement of the element driving the bread during the operation of slicing the latter, comparing the speed of movement of the drive element with a predetermined speed and respectively increasing or decreasing the power of the means of moving said drive element when said speed of movement is respectively less than or greater than the predetermined speed.

By virtue of the means of automatically regulating the power of the motor according to the speed and/or the acceleration of the bread driving element of the device according to the invention by comparing the speed of movement of the drive element with a predetermined speed and adjusting the power of the movement means according to the difference between the speed of movement in question and the predetermined speed, the slicing of bread is always optimized according to the type of bread in question. This is because, when the bread opposes a high resistance to the blades at the start of slicing, that is to say when the crust of the bread is hard, the speed of movement of the driving element will be rapidly and greatly reduced and this strong rapid deceleration will be noted by the regulation means, which will decrease the power supplied by the means of moving the drive element, and the crust will consequently be sliced without its being broken by crushing the bread on the blades because of an excessively high speed and/or excessively great acceleration of movement of the bread driving element. Once the thickness of the crust has been passed by the blades and the cutting of the inside begun, the resistance of the bread to the blades decreases and the speed of movement of the element driving the bread increases. If this speed does not exceed a predetermined threshold value, the power supplied by the means of moving the drive element is increased in steps until said threshold value is reached. Thus, whatever the consistency, soft or firm, of the bread, the speed and/or acceleration of movement of the bread driving elements are controlled so as to prevent tearing of the inside because of excessive speed or acceleration or on the contrary the appearance of pilling of this inside through an excessively slow movement of the bread driving element and consequent excessive rubbing of the blades on the inside. Consequently no further phenomenon of crushing of crust or tearing of inside is observed by virtue of the device according to the invention.

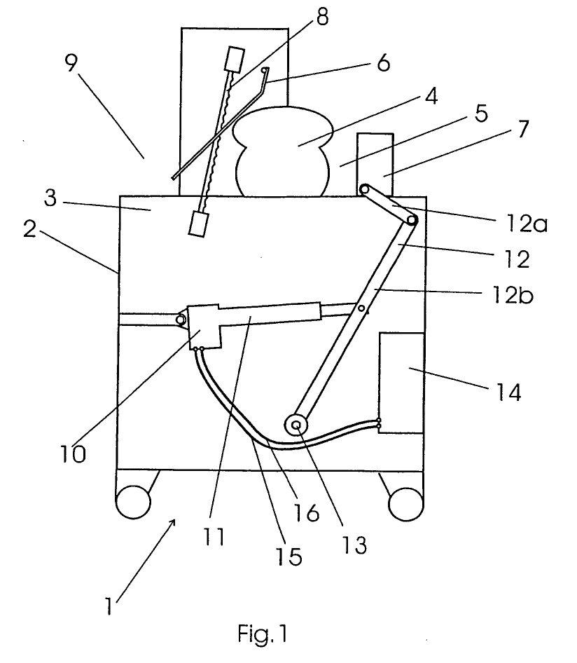

The invention will now be described in more detail by means of an example illustrating a non-limiting embodiment of its scope and with reference to the accompanying FIG. 1 depicting in schematic view in transverse section of a device according to the invention.

The device 1 according to the invention comprises a chassis 2 comprising a slicing table 3 for a loaf of bread 4 that is disposed in a loading compartment 5 of the device. The latter also comprises an element 7 for driving the bread 4 and a set of blades 8 disposed substantially parallel to one another and arranged so as to be driven in an alternating reciprocating movement in order to cut the bread 4 into slices. A bread press 6 is also provided, consisting of a blade exerting pressure on the top of the bread in order to prevent its juddering during the slicing operation. On the side of the set of blades 8 opposite to the loading compartment 5 for the bread 4 there is provided a compartment 9 for discharging the bread 4 cut into slices. The element 7 driving the bread 4 is arranged so as to be moved in a translation movement parallel to the slicing table 3 and transversely to the set of blades 8 between a first retracted position in which a loaf of bread 4 can be introduced into the loading compartment 5 and a second advanced position in which the bread driving element 7 is adjacent to the set of blades 8 and the bread 4 cut into slices and disposed in the discharge compartment 9 can be removed from the device 1. The movement of the drive element 7 is effected by means of an electric motor 10 comprising a rotor and a stator, coupled to said drive element 7 by a ram 11 actuating an articulated arm 12 comprising a first element 12a articulated by a hinge or swivel on a second element 12b, the first end of the arm 12 being able to pivot about a pivot 13 and a second end of said arm 12 being connected to the drive element 7. Alternatively to the electric motor 10, another means of moving the drive element 7 can be provided, for example a source or reservoir of compressed air actuating for example a pneumatic ram.

The power supplied by the motor 10 coupled to the element 7 driving the bread 4 during the functioning of the device 1 is automatically regulated by a regulation means 14 according to the speed of said drive element 7, which is dependent on the resistance that the bread 4 and bread presser 6 oppose to the set of blades 8 during the operation of slicing said bread. This is because the bread presser 6, in exerting a pressure on said bread 4, increases the resistance that the latter by itself opposes to the set of blades 8. The regulation means 14 is arranged so as to measure the speed of rotation of the rotor in the stator of the motor 10 in order to determine the speed of translation movement of the drive element 7 for the bread 4 and is also arranged to compare the measured speed with a predetermined speed and to increase or decrease the power of the motor 10 when this measured speed is respectively less than or greater than the predetermined speed.

If another means of moving the drive element 7 is used, such as a source or reservoir of compressed air, it is the speed of movement of the drive element 7 itself that can be directly measured by the regulation means 14, for example by virtue of position sensors such as photoelectric cells disposed on the travel of the drive elements 7.

Thus, whatever the type of bread sliced, the speed of this slicing is continuously optimized by the device according to the invention. When bread with a hard or on the contrary very flexible crust is put to be sliced in the device according to the invention and the crust reaches the set of blades 8, a very great resistance to the translation movement of the element 7 driving the bread is opposed by the crust to the slicing by the set of blades 8, because of the hardness of the said crust or the compression of the bread with flexible crust. Even in the case of bread of another type, such a resistance may be caused principally then by the pressure exerted by the bread presser on the said bread. This resistance causes an intensity peak in the current consumed by the motor 10 which indicates that the power of this motor and therefore the current consumed must be reduced in order to prevent the bread crust being crushed against the blades because of an excessively high pressure exerted by the drive elements 7 on the bread. This intensity peak corresponds to a predetermined value and can be measured and the current and therefore the power of the motor 10 can in reaction be greatly reduced to another predetermined value so that the slicing of the bread crust is carried out in an optimum manner without crushing. This is why the regulation means 14 for the device 1 according to the invention is also arranged to reduce the intensity of the current consumed by the motor 10 to a first predetermined value when this intensity exceeds a second predetermined value.

In the case where a movement means other than the motor 10 is used, such as a source or reservoir of compressed air, the above-mentioned intensity peak is replaced by a pressure peak in the air used for moving the drive element 7. The regulated power is also in this case the pressure of the air in question.

Once the slicing of the bread crust has been carried out, the set of blades 8 attacks the slicing of the inside of the bread 4. If the speed of movement of the drive element 7 and therefore of slicing of the bread 4 is less than a predetermined value, the regulation means 14 will increase the power of the rotor 10 until this value is reached, so as to avoid an excessively slow speed resulting in excessive friction of the set of blades 8 on the inside of the bread 4 and the consequent appearance of pilling in this inside. If by chance, in the case for example of a bread with very light inside, the predetermined value of the speed of cutting of the bread were exceeded, the regulation means 14 would demand a reduction in the power of the motor 10 in order to prevent any tearing of the inside due to an excessive speed or acceleration of movement of the drive element 7. The regulation means 14 is also arranged so as to cause a reversal of direction of movement of the element 7 driving the bread 4 when it reaches its first or second position. This reversal can be caused in several ways. It can be controlled by at least one photoelectric cell (not illustrated) arranged to mark the arrival of the drive element 7 in its first or second position or alternatively by providing that the regulation means 14 be arranged to measure the number of turns made by the rotor of the motor 10 in its stator and to cause said reversal from one of the first or second positions of the drive element 7 when said number of turns reaches a predetermined value from the other one of the first or second positions of the drive element 7. Alternatively again or concomitantly, the reversal in question can be caused from one of the first or second positions of the drive element 7 when the intensity of the current consumed by the motor 10 exceeds a predetermined threshold value appearing when the drive element 7 abuts against a stop disposed at its first and/or second positions.

In practice, the regulation means 14 can comprise a circuit controlling the power supplied by the motor 10 controlled by an electronic chip programmed so as, from a measurement by an ammeter of the intensity of the current consumed by the motor 10 and the number of turns per unit of time of the rotor of said motor 10 in its stator, indicated for example by means of a counting disk coupled to said rotor, to calculate the speed and/or acceleration of the drive element 7 and control the above mentioned power control circuit. The regulation means 14 is connected to the motor 10 by a first electric cable 15 transmitting the current intensity and motor speed information mentioned above and a second electric cable 16 supplying the motor 10 with electricity.

1. A device 1 for the automated cutting of bread 4 into slices comprising an element 7 driving the bread 4 and a set of blades 8 cutting the bread 4 disposed substantially parallel to one another and arranged so as to be driven in an alternating reciprocating movement, the element 7 driving the bread 4 being arranged so as to be moved in a translation movement transverse to the set of blades 8 by a movement means 10 coupled to said drive element 7 between a first retracted position in which the bread 4 to be sliced can be loaded in the device 1 and a second advanced position in which the element 7 driving the bread 4 is adjacent to the set of blades 8 and the sliced bread can be removed from the device 1, the latter also comprises a regulation means 14 arranged so as to automatically regulate the power supplied by the movement means 10 according to the speed and/or acceleration of the translation movement of the element 7 driving the bread 4 during the operation of slicing it, said regulation means 14 being arranged to compare the speed of movement of the drive element 7 with a predetermined speed and for respectively increasing or reducing the power of the means 10 of moving said drive element 7 when said movement speed is respectively less than or greater than the predetermined speed.

2. The device 1 as claimed in claim 1, wherein said movement means 10 is an electric motor comprising a rotor and a stator and said regulation means 14 is arranged to measure the speed of rotation of the rotor in the stator in order to determine the speed of translation movement of the element 7 driving the bread 4.

3. The device 1 as claimed in claim 2, wherein said regulation means 14 is arranged to reduce the intensity of the current consumed by said motor 10 to a first predetermined value when this intensity exceeds a second predetermined value.

4. The device 1 as claimed in claim 2, wherein said regulation means 14 is arranged to cause a reversal of the direction of movement of the element 7 driving the bread 4 when it reaches its first or second position.

5. The device 1 as claimed in claim 4, wherein said reversal is controlled by at least one photoelectric cell arranged so as to mark the arrival of the drive element 7 in its first or second position.

6. The device 1 as claimed in claim 4, wherein said regulation means 14 is arranged to measure the number of turns made by the rotor of the motor 10 in its stator and to cause said reversal from one of the first or second positions of the drive element 7 when said number of turns reaches a predetermined value from the other one of the first and second positions of the drive element 7.

7. The device 1 as claimed in claim 4, wherein said reversal is caused from one of the first or second positions of the drive element 7 when the intensity of the current consumed by the motor 10 exceeds a predetermined value.

8. The device 1 as claimed in any one of claims 2 to 7 claim 2, wherein the motor 10 is coupled to the drive element 7 by means of a ram 11 and an articulated arm 12.

9. The device 1 as claimed in claim 1, wherein said movement means 10 is a source or reservoir of compressed air.
